(19) United States
(12) Patent Application Publication
(10) Pub. No.: US 2025/0102348 A1
(43) Pub. Date: Mar. 27, 2025

(54) SHOPPING CART COMPRISING A WEIGHING KIT

(71) Applicant: SHEKEL SCALES (2008) LTD, Nof Hagalil (IL)

(72) Inventors: Shlomi TZUBERI, Afula (IL); Claudio KUDLACH, Kfar Tavor (IL)

(21) Appl. No.: 18/976,416

(22) Filed: Dec. 11, 2024

Related U.S. Application Data
(63) Continuation of application No. PCT/IB2023/056571, filed on Jun. 26, 2023.

(30) Foreign Application Priority Data
Jun. 26, 2022 (GB) 2209346.2

(51) Int. Cl. G01G 19/12; B62B 3/14; G01G 3/12; G01G 23/36

(52) U.S. Cl. CPC G01G 19/12; B62B 3/1424; B62B 3/1496; G01G 3/12; G01G 23/36

(57) ABSTRACT

A shopping cart comprises a basket and a wheeled base. An upper portion of the base has a coupling feature reversibly joined to a lower portion of the basket when the shopping cart is in an assembled, non-weighing configuration. The cart further comprises a weighing kit assembled from a lower frame, an upper frame with a coupling feature that emulates the coupling feature of the upper portion of the base member, and a load-cell assembly that mediates between the upper and lower frames. The lower frame is designed for being reversibly joined to the coupling feature of the base member, whilst the coupling feature of the upper frame of the weighing kit is designed to be reversibly joined to the basket member.

### CROSS-REFERENCE TO RELATED APPLICATIONS

This patent application is continuation of PCT/IB2023/056571 filed on Jun. 26, 2023, which is incorporated herein by reference in its entirety.

### FIELD OF THE INVENTION

The present invention relates to weighing devices and assemblies, including weighing modules and weighing kits, e.g., retrofit kits, for shopping carts.

### BACKGROUND

Shopping carts, also called shopping trolleys, are increasingly being provided with devices and systems for making grocery and other retail shopping experiences autonomous, i.e., independent of the need to undergo a checkout process. While unattended checkout technology, typically including barcode scanning supplemented with a weight sensor for theft protection, has been available for some time, it still requires shoppers to remove their selected items from their shopping baskets for identification by the unattended checkout system. In some cases, new shopping carts have been designed to incorporate various technology packages such as barcode scanning, optical imagers, and/or weighing systems. However, there is a need for a reliable and accurate weighing kit that can be incorporated in existing shopping carts designs, and even in already deployed shopping carts as a retrofit kit.

### SUMMARY

Embodiments of the present invention relate to weighing kits for shopping carts, as well as to shopping cart comprising weighing kits. Some of the embodiments relate to shopping carts which are non-destructively disassemblable, without tools, and/or with hand tools or small power tools such as screwdrivers, and/or without cutting tools or other destructive tools. According to embodiments, the weighing kits can be installed as a retrofit to a shopping cart, including shopping carts which have already been in use, and the installing is without tools and/or with hand tools and/or small power tools such as screwdrivers. Once installed, one or more load cell assemblies of the weighing kit registers, and can report and/or display the weight of the basket member of the shopping cart as well as of items placed into the basket.

According to embodiments, a shopping cart comprises a basket member comprising a volume for holding products, and a base member comprising a plurality of wheels supporting the base member. An upper portion of the base member comprises a coupling feature shaped and arranged to be reversibly joined to a lower portion of the basket member when the shopping cart is in an assembled, non-weighing configuration. The shopping cart also comprises a weighing kit comprising a lower frame, an upper frame comprising a coupling feature that emulates the coupling feature of the upper portion of the base member, and a load-cell assembly mediating between the lower frame and the upper frame, the load cell assembly comprising a flexure arrangement and a strain gage. When the shopping cart is in an assembled weighing-enabled configuration such that a weight of the basket member is registered by the strain gage, the lower frame of the weighing kit is joined to the coupling feature of the base member and is non-destructively separable therefrom, and the coupling feature of the upper frame of the weighing kit is joined to the basket member and is non-destructively separable therefrom.

A method is disclosed, according to embodiments, for assembling a weighing-enabled shopping cart. The method comprises: providing a basket member of a shopping cart, a base member of a shopping cart, and a weighing kit. The basket member comprises a volume for holding products, and the base member comprises a plurality of wheels supporting the base member. An upper portion of the base member comprises a coupling feature shaped and arranged to be reversibly joined to a lower portion of the basket member. The weighing kit comprises a lower frame shaped for being joined to the base member, an upper frame comprising a coupling feature that emulates the coupling feature of the upper portion of the base member, and a load cell assembly comprising a flexure arrangement and a strain gage. The method further comprises joining the lower frame of the weighing kit to the base member and the coupling feature of the upper frame of the weighing kit to the basket member, and installing the load cell assembly between the lower frame and the upper frame to mediate therebetween.

A method is disclosed, according to embodiments, for converting a shopping cart from a non-weighing configuration to a weighing-enabled configuration. The shopping cart comprises a basket member and a base member, and an upper portion of the base member comprises a coupling feature reversibly joined, without welding, to a lower portion of the basket member. The method comprises: non-destructively separating the basket member of the shopping cart from the base member thereof, and providing a weighing kit. The weighing kit comprises a lower frame shaped for being joined to the base member, an upper frame comprising a coupling feature that emulates the coupling feature of the upper portion of the base member, and a load cell assembly comprising a flexure arrangement and a strain gage. The method also comprises joining the lower frame of the weighing kit to the base member and the coupling feature of the upper frame of the weighing kit to the basket member, and installing the load cell assembly between the lower frame and the upper frame to mediate therebetween.

According to embodiments, a shopping cart comprises: a basket member comprising a volume for holding products, a base member comprising a plurality of wheels supporting the base member, a weighing kit comprising one or more load-cell assemblies, and a shelf member suspended from the basket member and/or from an upper frame of the weighing kit. Each load cell assembly comprises a flexure arrangement and a strain gage, and the weighing kit is interposed between the basket member and the base member, such that the one or more strain gages register a weight of the basket member, and a weight of the suspended shelf member is registered by the one or more strain gages.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 is a schematic perspective view of a shopping cart according to embodiments of the present invention.

FIG. 2 shows the shopping cart of FIG. 1 with the basket member partly disconnected from the base member, according to embodiments of the present invention.

FIG. 3 shows the shopping cart of FIGS. 1 and 2 with the basket member fully disconnected from the base member, according to embodiments of the present invention.

FIGS. 4A and 4B are, respectively, elevation and exploded perspective views of a weighing kit according to embodiments of the present invention.

FIG. 5 shows a detail for FIG. 3 encompassing a connection frame of the base member, according to embodiments of the present invention.

FIG. 6 shows an exemplary block diagram of electronic circuitry hardware according to embodiments of the present invention.

FIGS. 7A and 7B shows flowcharts of methods and method steps for assembling an apparatus, according to embodiments of the present invention.

FIGS. 8A, 8B, 8C, 8D, 8E, 8F, and 8G show flowcharts of methods and method steps for manufacturing a weighing-enabled shopping cart, according to embodiments of the present invention.

FIGS. 9A and 9B schematically illustrate the joining of a lower frame of a weighing kit to a base member of a shopping cart, according to embodiments of the present invention.

FIGS. 10A and 10B schematically illustrate the joining of an upper frame of a weighing kit to a basket member of a shopping cart, according to embodiments of the present invention.

FIG. 11 is a schematic view of an assembled shopping cart comprising a weighing kit and a cart handle, according to embodiments of the present invention.

FIG. 12 shows a flowchart of a method for converting a shopping cart from a non-weighing configuration to a weighing-enabled configuration, according to embodiments of the present invention.

FIGS. 13A and 13B are respective elevation and front perspective views of an assembled shopping cart comprising a weighing kit and a suspended shelf, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Embodiments of the invention relate to shopping carts that include weighing kits, and weighing kits for shopping carts, as well as methods of assembly and manufacture. In some of the embodiments, the weighing kits can be installed as retrofit smart weighing solutions for shopping carts. In such embodiments, the weighing kits are designed to be installed between the base of a shopping cart and its basket, and this approach is particularly well suited to shopping carts in which the basket member can be non-destructively separated from the base. Post-installation, the upgraded shopping carts can register any item placed into (or removed from) the basket member. In some embodiments, the weighing kits include attachment frames that emulate portions of the base and basket that are used normally for coupling (before installing the weighing kit), such that a lower attachment frame can be joined to the base, and the upper attachment frame can be joined to the basket, in much the same process used for assembling the major parts of the shopping cart without a weighing kit.

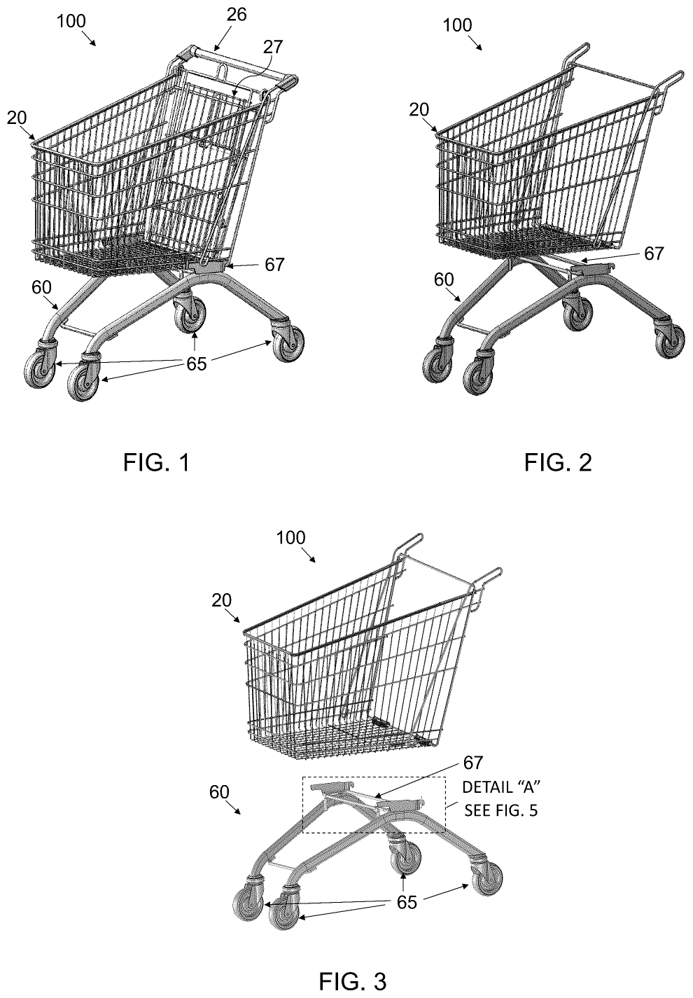

Referring now to the figures, FIG. 1 illustrates an exemplary shopping cart 100. The cart 100 of FIG. 1 is characterized by having a base member 60 and a basket member 20 which are configured for easy mechanical assembly and disassembly. The easy mechanical assembly means that the base and basket members 20, 60 can be coupled to each other, or are coupled to each other, without welding. The easy disassembly means that once coupled together, i.e., directly coupled to each other, the base member 60 and the basket member 20 are non-destructively separable from each other. According to embodiments, the base member 60 and basket member 20 are not welded to each other, which would require cutting tools and/or other destructive means to separate the two portions, and instead the two portions can be separated either without tools, or with hand tools alone, and/or with small power tools such as a screwdriver (but not cutting tools). FIG. 1 shows the base member 60 and basket member 20 in a coupled state, wherein the base member 60 and the basket member 20 are mechanically coupled to each other without welding, and non-destructively separable from each other.

The base member 60 includes a plurality, e.g., 3 or 4 or 5, wheels 65 which support the weight of the base 60 as well as the other components of the cart 100. A connection frame 67 for connecting the basket member 20 with the base member 60 is installed, e.g., atop the base member 60 for effecting mechanical assembly and disassembly, e.g., permanently or with reversible fasteners such as screws and/or bolts.

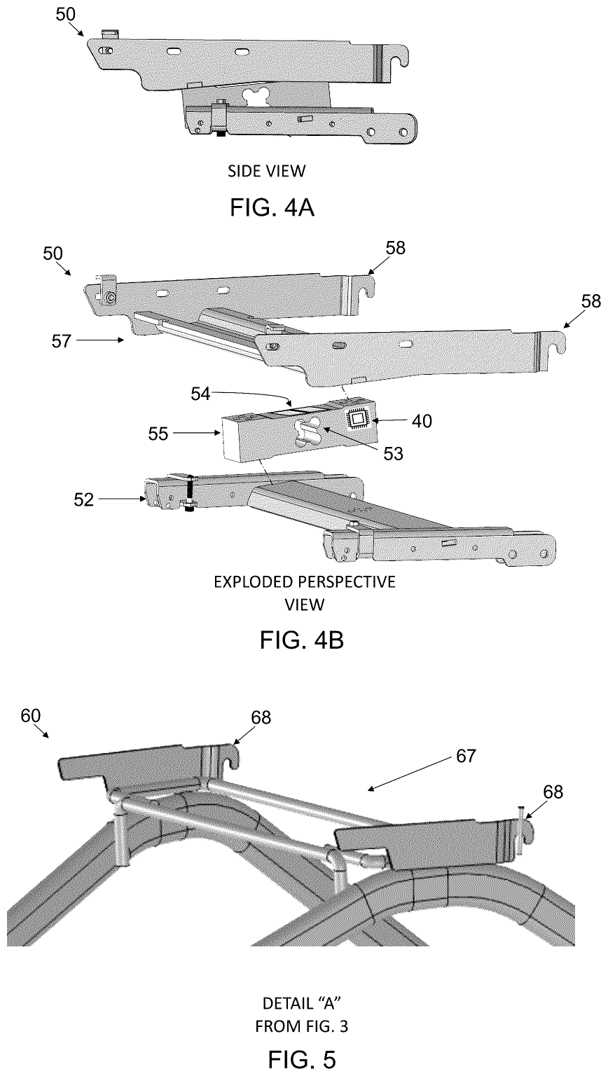

FIG. 2 shows a non-limiting example of a process step for separating the basket member 20 from the base member 60. As can be seen in FIG. 2, a rear end of the basket member 20 is tipped up as the basked portion 20 pivots off the connection frame 67. In some embodiments, one or more fasteners such as screws or bolts have to be removed before the basket member 20 can be removed. The back wall 27 and the push handle 26, visible in FIG. 1, have been removed in FIG. 2. In some embodiments, the back wall 27 and the push handle 26 are replaced by a cart handle that directs some load, e.g., of a person holding or pushing the cart handle, away from the weighing kit. The base member 60 and basket member 20 are seen in an unassembled, or disassembled state, in FIG. 3, with the basket member 20 lacking the back wall 27 and the push handle 26.

FIGS. 4A and 4B show an exemplary weighing kit 50 according to embodiments. The weighing kit is configured to mediate between the base member 60 and the basket member 20 by being physically installed therebetween. Here too, the installation is preferably of the type wherein the base and basket members 20, 60 are coupled to the weighing kit 50 each other without welding, either without tools, or with hand tools alone, and/or with small power tools such as a screwdriver, and can be disassembled in a similar, non-destructive manner. As can be seen in the exploded view of FIG. 4B, the weighing kit 50 comprises an upper frame 57, a lower frame 52, and a load cell assembly 55 mediating between the two frames 57, 52. The upper frame 57 is shaped for being joined to the bottom of the basket member 20, while the lower frame 52 is shaped for being joined to the base member 60, and more specifically to the connection frame 67. It can be desirable for the upper frame 57 to be shaped to emulate an upper portion of the connection frame 67 so that the basket member 20 can be joined to the upper frame 57 with equal or similar case and methods as being joined to the connection frame 67. FIG. 5, which shows in greater detail the connection frame 67 of FIG. 3, demonstrates that the upper frame 57 includes features 58 which emulate similar features 68 of the connection frame 67. In the non-limiting example of FIGS. 4B and 5, the features 58, 68 include a crimped plate leading to a curved hooked portion. In other examples, the shapes of the features 58, 68 may be different from those shown in FIGS. 4B and 5, e.g., in accordance with the shape of the basket member 20 and the method of joining to it.

Still referring to FIG. 4B, the load cell assembly 55 includes a flexure arrangement 53 and one or more strain gages for translating the mechanical strain at or downstream of the flexure to an electrical signal which is processed, e.g., by electronic circuitry 51. Throughout the figures, the weighing kit 50 is illustrated as including exactly one load cell assembly 55; this is only for convenience, and in other examples the weighing kit includes multiple load cell assemblies, for example, 2, 3 or 4 load cell assemblies. In one example (not shown), the weighing kit includes two load cell assemblies, and the electronic circuitry is configured, e.g., arranged and/or programmed, to receive inputs from the two load assemblies. In said example, the load cell assemblies may be less robust physically than that used in the single-assembly versions. In some examples, the load cell assemblies can include multiple prismatic load cells.

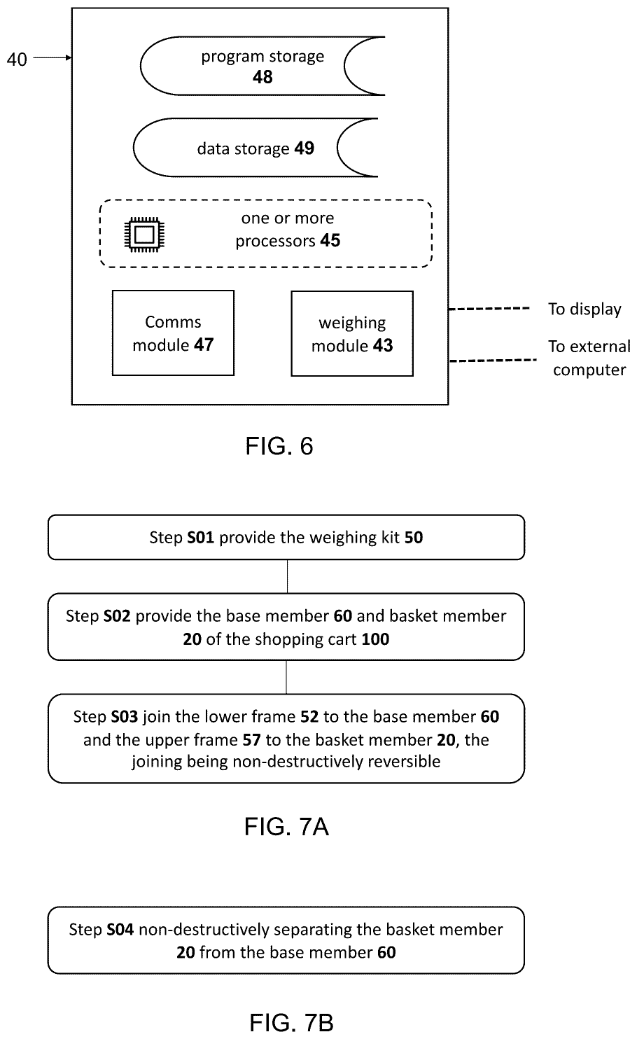

FIG. 6 shows a block diagram of electronic circuitry 40. The term “electronic circuitry” is used to mean any hardware, software and/or firmware deployed in connection with, inter alia, data communication, programming, data processing, data storage, measurements, and/or calculations. In the instant example, the electronic circuitry 40 can include, and not exhaustively, any or all of the components illustrated in FIG. 6: one or more computer processors 45; program storage 48 for storing therein program instructions for execution by the one or more computer processors 45; transient and/or non-transient data storage 45 for storing therein measurements, calculations, and/or historical data; a weighing module 43 for handling information received from the one or more strain gages 54, e.g., for translating electric signals to weight information; and a communications module 47, e.g., for communicating information about weighing to a display and/or to an external computer. A power source for the electronics can be provided but is not shown in FIG. 6. In some embodiments, the electronic circuitry 40 includes, and stores for execution by the one or more processors 45, program instructions for transmitting information about a weight registered by the strain gage 53, e.g., to an external computer. In some embodiments, the electronic circuitry 40 includes, and stores for execution by the one or more processors 45, program instructions for recording, e.g., in a non-transient computer-readable medium of the data storage 49, a weight of an item placed in the basket member 20 by a user. In some embodiments, the electronic circuitry 40 includes, and stores for execution by the one or more processors 45 program instructions for displaying, on a screen, a weight of a load registered by the strain gage 53, e.g., of an item placed in the basket member 20 by a user. In some embodiments, the electronic circuitry includes, and stores for execution by the one or more processors 45, program instructions for subtracting the weight of the basket member 20 from a total weight measured or calculated by the load cell assembly 55, and/or to display or record a result of the subtracting. In embodiments, not every load cell assembly 55 includes all of the electronic circuitry components shown in FIG. 6.

Referring now to FIG. 7A, a method is disclosed for assembling an apparatus according to any one or more of the apparatuses disclosed herein. As illustrated by the flowchart in FIG. 7A, the method comprises at least the three method steps S01, S02, and S03:
Step S01: providing the weighing kit 50.
Step S02: providing the base member 60 and basket member 20 of the shopping cart 100. In some embodiments, the base member 60 and basket member 20 provided are mechanically coupled to each other without welding before the providing.
Step S03: joining the lower frame 52 to the base member 60 and the upper frame 57 to the basket member 20, the joining being non-destructively reversible.

In some embodiments, e.g., embodiments in which the base member 60 and basket member 20 provided are mechanically coupled to each other without welding before the providing of Step S02, the method additionally comprises method Step S04, illustrated by the flow chart in FIG. 7B.
Step S04: non-destructively separating the basket member 20 from the base member 60. According to the embodiments, Step S04 is performed before the joining of Step S03.

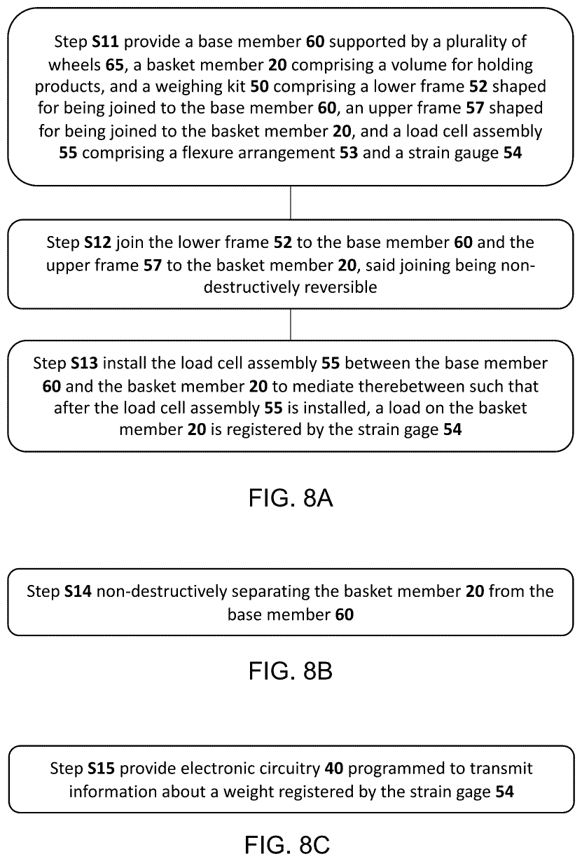

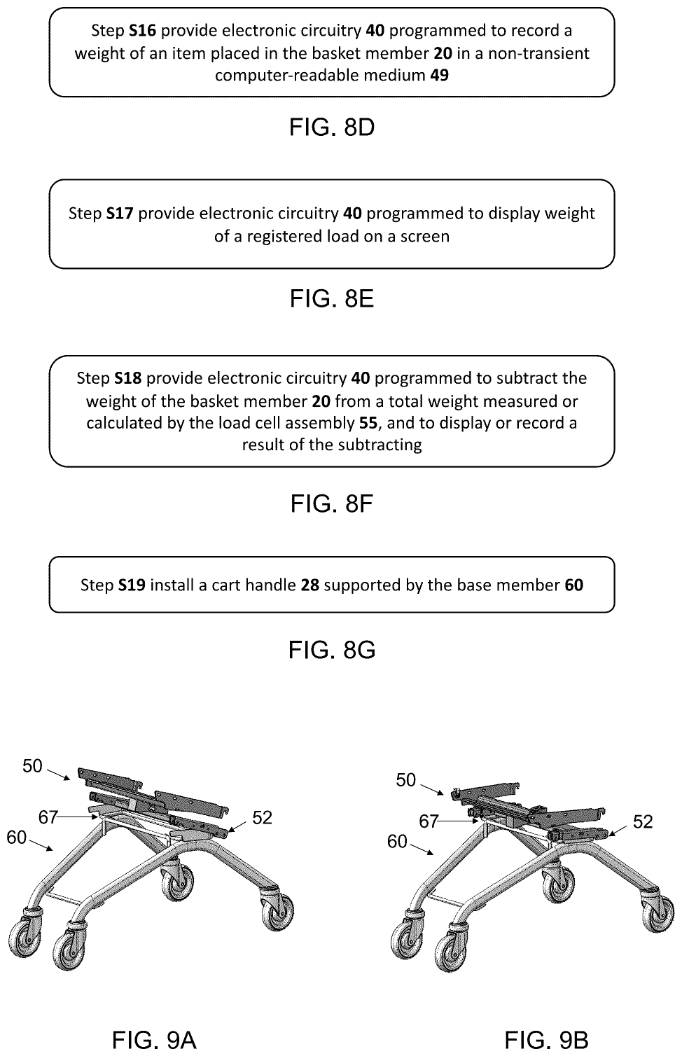

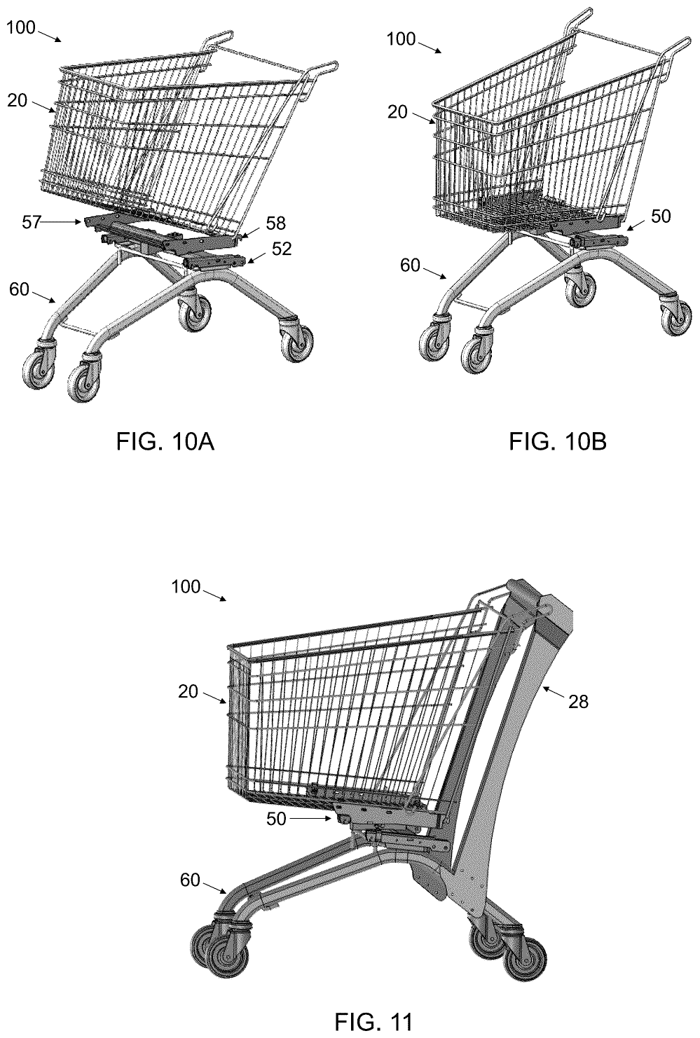

Referring now to FIG. 8A, a method is disclosed for manufacturing a weighing-enabled shopping cart. As illustrated by the flowchart in FIG. 8A, the method comprises at least the three method steps S11, S12, and S13:
Step S11: providing a base member 60 supported by a plurality of wheels 65; a basket member 20 comprising a volume for holding products; and a weighing kit 50 comprising: a lower frame 52 shaped for being joined to the base member 60, an upper frame 57 shaped for being joined to the basket member 20, and a load cell assembly 55 comprising a flexure arrangement 53 and a strain gauge 54. In some embodiments, the weighing kit 50 is provided in an assembled state wherein the load cell assembly 55 is installed between the lower frame 52 and the upper frame 57.
Step S12: joining the lower frame 52 to the base member 60, and the upper frame 57 to the basket member 20. In some embodiments, this joining is non-destructively reversible. In some embodiments, the base member 60 and basket member 20 provided are mechanically coupled to each other without welding before the providing. FIGS. 9A and 9B illustrate the joining of the lower frame 52 to the base member 60, in an example in which the installation step of Step S13, i.e., the installation of the load cell assembly 55 between the base member 60 and the basket member 20, has already been performed. In this example, the lower frame 52 can be seen as being ‘hooked’ on the features 68 of the connection frame 67 in FIG. 9A, and then tipped forward to complete the joining in FIG. 9B. FIGS. 10A and 10B illustrate the joining of the basket member 20 to the upper frame 57, in the same example in which the installation of the load cell assembly 55 between the base member 60 and the basket member 20, has already been performed. In this example, the basket 20 can be seen as being ‘hooked’ on the features 58 of upper frame 57 in FIG. 10A, and then tipped forward to complete the joining in FIG. 10B. In all of FIGS. 9A, 9B, 10A, and 10B, only essential steps are shown; optional use of hand tools, small power tools such as a screwdriver, and fasteners such as screws and bolts (and accessories, e.g., nuts) is not shown.
Step S13: installing the load cell assembly 55 between the base member 60 and the basket member 20 to mediate therebetween such that after the load cell assembly 55 is installed, a load on the basket member 20 is registered by the strain gage 54. In some embodiments, a weight of the basket member 20 is registered by the strain gage 53 after the joining and the installing. In some embodiments, Step S13 is performed before Step S12.

In some embodiments, e.g., embodiments in which the base member 60 and basket member 20 provided are mechanically coupled to each other without welding before the providing of Step S12, the method additionally comprises method Step S14, illustrated by the flow chart in FIG. 8B.
Step S14: non-destructively separating the basket member 20 from the base member 60. According to the embodiments, Step S04 is performed before the joining of Step S13.

In some embodiments, the method additionally comprises method step S15, illustrated by the flow chart in FIG. 8C:
Step S15: providing electronic circuitry 40 programmed to transmit information about a weight registered by the strain gage 54.

In some embodiments, the method additionally comprises method step S16, illustrated by the flow chart in FIG. 8D:
Step S16: providing electronic circuitry 40 programmed to record a weight of an item placed in the basket member 20 in a non-transient computer-readable medium 49.

In some embodiments, the method additionally comprises method step S17, illustrated by the flow chart in FIG. 8E:
Step S17: providing electronic circuitry 40 programmed to display weight of a registered load on a screen.

In some embodiments, the method additionally comprises method step S18, illustrated by the flow chart in FIG. 8F:
Step S18: providing electronic circuitry 40 programmed to subtract the weight of the basket member 20 from a total weight measured or calculated by the load cell assembly 55, and to display or record a result of the subtracting.

In some embodiments, the method additionally comprises method step S19, illustrated by the flow chart in FIG. 8G:
Step S19: installing a cart handle 28 supported by the base member 60. FIG. 11 shows an example of a cart handle 28 suitable for replacing the back wall 27 and the push handle 26 shown in FIG. 1. The cart handle is designed to be supported by the base member 60 so that the load cell assembly 55 does not register the load of a user leaning on the push handle 26, or even just pushing the shopping cart 100. The cart handle 27 is thus configured to ‘bypass’ the load cell assembly 55.

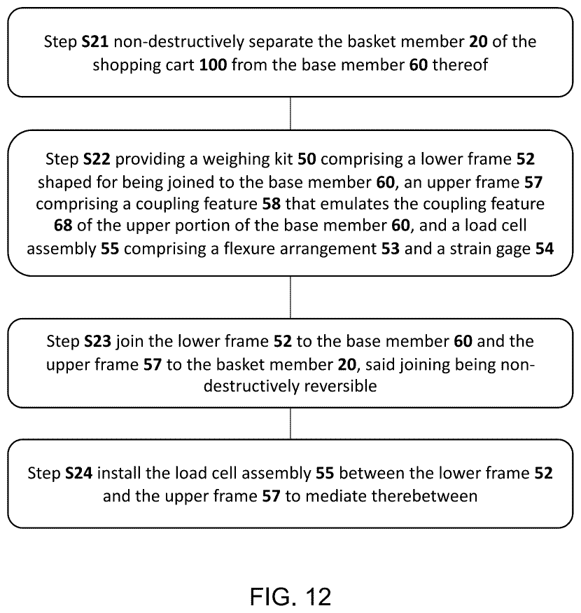

Referring now to FIG. 12, a method is disclosed for converting a shopping cart 100 from a non-weighing configuration to a weighing-enabled configuration, and in particular, a shopping cart 100 comprising a basket member 20 and a wheeled base member 60. According to the method, an upper portion of the base member 60 comprises a coupling feature 68 reversibly joined without welding, before the converting, to a lower portion of the basket member 20. As illustrated by the flowchart in FIG. 12, the method comprises at least the three method steps S21, S22, S23, and S24:
Step S21 includes non-destructively separating the basket member 20 from the base member 60.
Step S22 includes providing a weighing kit 50 comprising a lower frame 52 shaped for being joined to the base member 60, an upper frame 57 comprising a coupling feature 58 that emulates the coupling feature 68 of the upper portion of the base member 60, and a load cell assembly 55 comprising a flexure arrangement 53 and a strain gage 54.
Step S23 includes joining the lower frame 52 of the weighing kit 50 to the base member 60, and the coupling feature 58 of the upper frame 57 of the weighing kit 50 to the basket member 20. In some embodiments, the joining is non-destructibly reversible and/or is performed without welding.
Step S24 includes installing the load cell assembly 55 between the lower frame and the upper frame to mediate therebetween.

In some embodiments, the method is performed in the foregoing order. In some embodiments, Step S24 is performed before Step S23. In some embodiments, Step S24 is performed before Step S22.

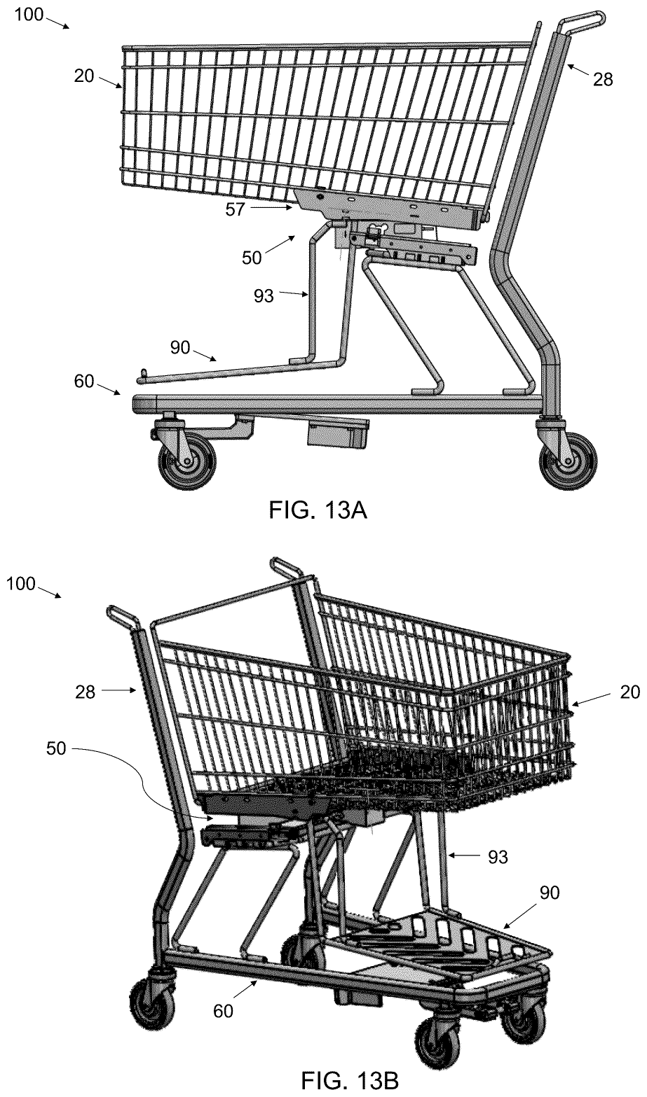

Reference is now made to FIGS. 13A and 13B. In any of the embodiments disclosed herein, a shopping cart 100 can include a shelf member 90 suspended from the basket member 20 and/or from the upper frame 57 of the weighing kit 50. The shelf 90 is suspended in such a way that the weight of the suspended shelf member-and of any products placed on the shelf-is registered by the one or more strain gages 54 of the load cell assembly 55. FIGS. 13A and 13B show two views of a non-limiting example of such a suspended shelf 90. In this exemplary configuration, the shelf member 90 is suspended from the upper frame 57 of the weighing kit 50 by suspension rods 93. In other examples (not shown) the shelf member 90 is suspended from the basket portion. The skilled artisan will understand that despite being physically lower than the weighing kit, the load of the suspended shelf member (and any products placed upon the shelf) is borne by the load cell assembly of the weighing kit.

In embodiments, other receptacles and supports can be added to shopping carts. For example, a shopping cart according to any of the disclosed embodiments can further comprise an additional basket member arranged so that the weight of the additional basket is registered by the strain gage of the load cell assembly. As another example, a child-seat shelf can be added to a cart such that the child-seat shelf is supported by a handle member (the load of which is not borne by the weighing kit, e.g., handle member 28 of FIG. 11).

The embodiments disclosed describe shopping carts in varying configurations: for example, a shopping cart which has to be assembled in order to become a weighing-enabled shopping cart, and a shopping cart which is convertible from a non-weighing configuration to a weighing-enabled configuration. In other examples, the shopping cart is provided fully assembled in a weighing-enabled configuration. In some such examples, the respective weighing kit is non-destructibly separable from the respective basket and base members, and in other examples, the joining of the upper frame of the weighing kit to the basket member of the shopping cart, and of the lower frame of the weighing kit to the base member, can be by a joining method, e.g., welding, that is irreversible without causing damage. Any of these examples can be combined with any of the shopping-cart features disclosed herein, such as, and not exhaustively: an independent, i.e., unweighed, handle member; a suspended lower shelf; and one or more additional weighed basket members.

### Additional Embodiments

An apparatus according to embodiments comprises a weighing kit 50. The weighing kit 50 is configured to mediate between a base member 60 of a shopping cart 100 and a basket member 20 of the shopping cart 100; the base member 60 and the basket member 60 are configured for mechanical coupling to each other without welding such that, when directly coupled to each other without the weighing kit 50, the base member 60 and the basket member 20 are non-destructively separable from each other. The weighing kit 50 comprises: (a) a lower frame 52 shaped for being joined to the base member 60, (b) an upper frame 57 shaped for being joined to the basket member 20, and (c) a load cell assembly 55 comprising a flexure arrangement 53 and a strain gauge 54, the load cell assembly 55 mediating between the lower frame 52 and the upper frame 57 such that when the apparatus is in an assembled state in which the weighing kit 50 is installed between the base member 60 and the basket member 20 such that the lower frame 52 is joined to the base member 60 and the upper frame 57 is joined to the basket member 20, a load on the basket member 20 is registered by the strain gage 54.

In some embodiments, the joining of the lower frame 52 to the base member 60 and/or of the upper frame 57 to the basket member 20 can be non-destructively reversible.

In some embodiments, a weight of the basket member 20 can be registered by the strain gage 54.

In some embodiments, the apparatus can comprise electronic circuitry 40 programmed to transmit information about a weight registered by the strain gage 54. In some embodiments, the apparatus can comprise electronic circuitry programmed to record, in a non-transient computer-readable medium 49, a weight of an item placed in the basket member 20. In some embodiments, the apparatus can comprise electronic circuitry programmed to display, on a screen, a weight of a registered load. In some embodiments, the apparatus can comprise electronic circuitry programmed to subtract the weight of the basket member 20 from a total weight measured or calculated by the load cell assembly 55, and/or to display or record a result of the subtracting.

In some embodiments, the apparatus can additionally comprise the base member 60 and the basket member 20. In some such embodiments, the base member 60 and the basket member 20 can be mechanically coupled to each other without welding, and/or non-destructively separable from each other. In some such embodiments, the apparatus can be provided in the assembled state.

In some embodiments, the apparatus can additionally include a cart handle 28 supported by the base member 60.

According to some embodiments, a method is disclosed for assembling the apparatus. The method can comprise: (a) providing the weighing kit 50, (b) providing the base member 60 and basket member 20 of the shopping cart 100, and/or joining the lower frame 52 to the base member 60 and the upper frame 57 to the basket member 20, the joining being non-destructively reversible. In some such embodiments, the provided base member 60 and basket member 20 can be mechanically coupled to each other without welding, and/or the method can additionally comprise, before the joining: non-destructively separating the basket member 20 from the base member 60.

A weighing-enabled shopping cart 100 according to embodiments comprises: (a) a base member 60 comprising a plurality of wheels 65 supporting the base member 60, (b) a basket member 20 comprising a volume for holding products, and (c) a weighing kit 50 comprising a lower frame 52 joined to the base member 60 and non-destructively separable therefrom, an upper frame 57 joined to the basket member 20 and non-destructively separable therefrom, and a load cell assembly 55 mediating between the lower frame 52 and the upper frame 57, the load cell assembly 55 comprising a flexure arrangement 53 and a strain gauge 54 arranged such to register a weight of a product added to or removed from the holding volume of the basket member 20.

In some embodiments, a weight of the basket member 20 can be registered by the strain gage 54.

In some embodiments, the apparatus can comprise electronic circuitry 40 programmed to transmit information about a weight registered by the strain gage 54. In some embodiments, the shopping cart 100 can comprise electronic circuitry 40 programmed to record, in a non-transient computer-readable medium 49, a weight of a product placed in the holding volume of the basket member 20. In some embodiments, the shopping cart 100 can comprise electronic circuitry programmed to display, on a screen, a weight of an added or removed product. In some embodiments, the shopping cart 100 can comprise electronic circuitry programmed to subtract the weight of the basket member 20 from a total weight measured or calculated by the load cell assembly 55, and/or to display or record a result of the subtracting.

In some embodiments, the shopping cart 100 can additionally include a cart handle 28 supported by the base member 60.

A method is disclosed, according to embodiments, for manufacturing a weighing-enabled shopping cart 100. The method comprises: (a) providing: (i) a base member 60 of a shopping cart 100, the base member 60 comprising a plurality of wheels 65 supporting the base member 60, (ii) a basket member 20 of a shopping cart 100, the basket member 20 comprising a volume for holding products, and (iii) a weighing kit 50 comprising a lower frame 52 shaped for being joined to the base member 60, an upper frame 57 shaped for being joined to the basket member 20, and a load cell assembly 55 comprising a flexure arrangement 53 and a strain gauge 54. The method additionally comprises: (b) joining the lower frame 52 to the base member 60 and the upper frame 57 to the basket member 20, said joining being non-destructively reversible, and (b) installing the load cell assembly 55 between the lower frame 52 and the upper frame 57 to mediate therebetween such that after the load cell assembly 55 is installed, a load on the basket member 20 is registered by the strain gage 54.

In some embodiments, the provided base member 60 and basket member 20 can be mechanically coupled to each other without welding; the method can additionally comprise, before the joining: non-destructively separating the basket member 20 from the base member 60.

In some embodiments, the joining of the lower frame 52 to the base member 60 and of the upper frame 57 to the basket member 20 can be non-destructively reversible.

In some embodiments, it can be that after the joining and the installing, a weight of the basket member 20 is registered by the strain gage 54.

In some embodiments, the method can additionally comprise: providing electronic circuitry 40 programmed to transmit information about a weight registered by the strain gage 54. In some embodiments, the method can additionally comprise: providing electronic circuitry programmed to record, in a non-transient computer-readable medium 49, a weight of an item placed in the basket member 20. In some embodiments, the method can additionally comprise: providing electronic circuitry programmed to display, on a screen, a weight of a registered load. In some embodiments, the method can additionally comprise: providing electronic circuitry programmed to subtract the weight of the basket member 20 from a total weight measured or calculated by the load cell assembly 55, and/or to display or record a result of the subtracting.

In some embodiments, the installing can be performed before the joining.

In some embodiments, the weighing kit 50 can be provided in an assembled state wherein the load cell assembly 55 is installed between the lower frame 52 and the upper frame 57.

In some embodiments, the method can additionally comprise: installing a cart handle 28 supported by the base member 60.

### Inventive Concepts

A number of inventive concepts are disclosed herein, including, inter alia, the following.

Inventive Concept 1. A shopping cart comprising: (a) a basket member comprising a volume for holding products; (b) a base member comprising a plurality of wheels supporting the base member, an upper portion of the base member comprising a coupling feature shaped and arranged to be reversibly joined to a lower portion of the basket member when the shopping cart is in an assembled, non-weighing configuration; and (c) a weighing kit comprising (i) a lower frame, (ii) an upper frame comprising a coupling feature that emulates the coupling feature of the upper portion of the base member, and (iii) a load-cell assembly mediating between the lower frame and the upper frame, the load cell assembly comprising a flexure arrangement and a strain gage, wherein, when the shopping cart is in an assembled weighing-enabled configuration such that a weight of the basket member is registered by the strain gage, (i) the lower frame of the weighing kit is joined to the coupling feature of the base member and is non-destructively separable therefrom, and (ii) the coupling feature of the upper frame of the weighing kit is joined to the basket member and is non-destructively separable therefrom.

Inventive Concept 2. The shopping cart of Inventive Concept 1, wherein the weighing kit comprises electronic circuitry programmed to transmit information about a weight registered by the strain gage, the electronic circuitry being disposed on one or more of the lower frame, the upper frame, and the load-cell assembly.

Inventive Concept 3. The shopping cart of either one of Inventive Concepts 1 or 2, wherein the weighing kit comprises electronic circuitry disposed on one or more of the lower frame, the upper frame, and the load-cell assembly, and programmed to record, in a non-transient computer-readable medium, a weight of a product placed in the holding volume of the basket member or removed therefrom when the shopping cart is in the assembled weighing-enabled configuration.

Inventive Concept 4. The shopping cart of any one of the preceding Inventive Concepts, wherein the weighing kit comprises electronic circuitry disposed on one or more of the lower frame, the upper frame, and the load-cell assembly, and programmed to display, on a screen, a weight of a product added to or removed from the basket member when the shopping cart is in the assembled weighing-enabled configuration.

Inventive Concept 5. The shopping cart of any one of the preceding Inventive Concepts, wherein the weighing kit comprises electronic circuitry disposed on one or more of the lower frame, the upper frame, and the load-cell assembly, and programmed to subtract at least a weight of the basket member from a total weight measured or calculated by the load cell assembly when the shopping cart is in the assembled weighing-enabled configuration, and to display and/or record a result of the subtracting.

Inventive Concept 6. The shopping cart of any one of the preceding Inventive Concepts, additionally comprising a handle member supported solely by the base member such that when the shopping cart is in the assembled weighing-enabled configuration, the strain gage does not register a weight of the handle member.

Inventive Concept 7A. The shopping cart of any one of the preceding Inventive Concepts, additionally comprising a shelf member suspended from the basket member and/or from the upper frame of the weighing kit.

Inventive Concept 7B. The shopping cart of Inventive Concept 7A, wherein when the shopping cart is in the assembled weighing-enabled configuration, a weight of the suspended shelf member is registered by the strain gage.

Inventive Concept 8. The shopping cart of any one of the preceding Inventive Concepts, additionally comprising a second basket member comprising a volume for holding products and arranged such that a weight of the second basket member is registered by the strain gage when the shopping cart is in the assembled weighing-enabled configuration.

Inventive Concept 9. The shopping cart of any one of the preceding Inventive Concepts, wherein (i) the weighing kit additionally comprises at least one additional load-cell assembly, each additional load-cell assembly mediating between the lower frame and the upper frame, and comprising a flexure arrangement and a strain gage, (ii) when the shopping cart is in the assembled weighing-enabled configuration, a weight of the basket member is registered by, and distributed among, all of the strain gages of the weighing kit.

Inventive Concept 10. A method of assembling the shopping cart of any one of Inventive Concepts 1 to 9, the method comprising: (a) joining the lower frame of the weighing kit to the base member, and the coupling feature of the upper frame of the weighing kit to the basket member; and (b) installing the load cell assembly between the lower frame and the upper frame to mediate therebetween.

Inventive Concept 11. The method of Inventive Concept 10, wherein the installing is performed before the joining.

Inventive Concept 12. The method of either one of Inventive Concepts 10 or 11, wherein, after the joining and the installing, a weight of the basket member is registered by the strain gage

Inventive Concept 13. A method of converting, from the non-weighing configuration to the weighing-enabled configuration, the shopping cart of any one of Inventive Concepts 1 to 9, the method comprising: (a) non-destructively separating the basket member of the shopping cart from the base member thereof; (b) joining the lower frame of the weighing kit to the separated base member, and the coupling feature of the upper frame of the weighing kit to the separated basket member; and (c) installing the load cell assembly between the lower frame and the upper frame to mediate therebetween.

Inventive Concept 14. The method of Inventive Concept 13, wherein the installing is performed before the joining.

Inventive Concept 15. The method of either one of Inventive Concepts 13 or 14, wherein, after the joining and the installing, a weight of the basket member is registered by the strain gage

Inventive Concept 16. A method of assembling a weighing-enabled shopping cart, the method comprising: (a) providing: (i) a basket member of a shopping cart, the basket member comprising a volume for holding products, (ii) a base member of a shopping cart, the base member comprising a plurality of wheels supporting the base member, an upper portion of the base member comprising a coupling feature shaped and arranged to be reversibly joined to a lower portion of the basket member, and (iii) a weighing kit comprising a lower frame shaped for being joined to the base member, an upper frame comprising a coupling feature that emulates the coupling feature of the upper portion of the base member, and a load cell assembly comprising a flexure arrangement and a strain gage; (b) joining the lower frame of the weighing kit to the base member, and the coupling feature of the upper frame of the weighing kit to the basket member; and (c) installing the load cell assembly between the lower frame and the upper frame to mediate therebetween.

Inventive Concept 17. The method of Inventive Concept 16, wherein the installing is performed before the joining.

Inventive Concept 18. The method of Inventive Concept 16, wherein the installing is performed before the providing.

Inventive Concept 19. The method of any one of Inventive Concepts 16 to 18, wherein the provided base member and basket member are mechanically coupled to each other without welding, the method additionally comprising, before the joining: non-destructively separating the basket member from the base member.

Inventive Concept 20. The method of any one of Inventive Concepts 16 to 19, wherein the joining of the lower frame to the base member and the joining of the upper frame to the basket member are non-destructively reversible.

Inventive Concept 21. The method of any one of Inventive Concepts 16 to 20, wherein, after the joining and the installing, a weight of the basket member is registered by the strain gage.

Inventive Concept 22. The method of any one of Inventive Concepts 16 to 21, wherein the weighing kit comprises electronic circuitry disposed on one or more of the lower frame, the upper frame, and the load-cell assembly, and programmed to transmit information about a weight registered by the strain gage.

Inventive Concept 23. The method of any one of Inventive Concepts 16 to 22, wherein the weighing kit comprises electronic circuitry disposed on one or more of the lower frame, the upper frame, and the load-cell assembly, and programmed to record, in a non-transient computer-readable medium, a weight of an item placed in the basket member.

Inventive Concept 24. The method of any one of Inventive Concepts 16 to 23, wherein the weighing kit comprises electronic circuitry disposed on one or more of the lower frame, the upper frame, and the load-cell assembly, and programmed to subtract at least a weight of the basket member from a total weight measured or calculated by the load cell assembly, and to display and/or record a result of the subtracting.

Inventive Concept 25. The method of any one of Inventive Concepts 16 to 24, wherein the weighing kit is provided in an assembled state wherein the load cell assembly is installed between the lower frame and the upper frame.

Inventive Concept 26. The method of any one of Inventive Concepts 16 to 25, additionally comprising: installing a cart handle supported by the base member.

Inventive Concept 27. The method of any one of Inventive Concepts 16 to 26, additionally comprising: suspending a shelf member defining a volume for holding products from the basket member and/or from the upper frame of the weighing kit, such that a weight of the suspended shelf member is registered by the strain gage.

Inventive Concept 28. The method of any one of Inventive Concepts 16 to 27, additionally comprising: installing a second basket member comprising a volume for holding products, such that a weight of the second basket member is registered by the strain gage.

Inventive Concept 29. A weighing-enabled shopping cart assembled in accordance with the method of any one of Inventive Concepts 16 to 28.

Inventive Concept 30. A shopping cart converted from the non-weighing configuration to the weighing-enabled configuration in accordance with the method of any one of Inventive Concepts 19 to 28.

Inventive Concept 31. A method of converting, from a non-weighing configuration to a weighing-enabled configuration, a shopping cart comprising a basket member and a base member, wherein an upper portion of the base member comprises a coupling feature reversibly joined, without welding, to a lower portion of the basket member, the method comprising: (a) non-destructively separating the basket member of the shopping cart from the base member thereof; (b) providing a weighing kit comprising a lower frame shaped for being joined to the base member, an upper frame comprising a coupling feature that emulates the coupling feature of the upper portion of the base member, and a load cell assembly comprising a flexure arrangement and a strain gage; (c) joining the lower frame of the weighing kit to the base member, and the coupling feature of the upper frame of the weighing kit to the basket member; and (d) installing the load cell assembly between the lower frame and the upper frame to mediate therebetween.

Inventive Concept 32. The method of Inventive Concept 31, wherein the installing is performed before the joining.

Inventive Concept 33. The method of Inventive Concept 31, wherein the installing is performed before the providing.

Inventive Concept 34. The method of any one of Inventive Concepts 31 to 33, wherein the joining of the lower frame to the base member and the joining of the upper frame to the basket member are non-destructively reversible.

Inventive Concept 35. A shopping cart converted from the non-weighing configuration to the weighing-enabled configuration according to the method of any one of Inventive Concepts 31 to 34.

Inventive Concept 36. A shopping cart comprising: (a) a basket member comprising a volume for holding products; (b) a base member comprising a plurality of wheels supporting the base member; (c) a weighing kit comprising one or more load-cell assemblies, each load cell assembly comprising a flexure arrangement and a strain gage, the weighing kit interposed between the basket member and the base member such that the one or more strain gages register a weight of the basket member; and (d) a shelf member suspended from the basket member and/or from an upper frame of the weighing kit such that a weight of the suspended shelf member is registered by the one or more strain gages.

Inventive Concept 37. The shopping cart of Inventive Concept 36, wherein the weighing kit comprises electronic circuitry disposed thereupon and programmed to transmit information about a weight registered by the one or more strain gages.

Inventive Concept 38. The shopping cart of either one of Inventive Concepts 36 or 37, wherein the weighing kit comprises electronic circuitry disposed thereupon and programmed to record, in a non-transient computer-readable medium, a weight of a product placed in the holding volume of the basket member or removed therefrom, or of a product placed on the suspended shelf or removed therefrom.

Inventive Concept 39. The shopping cart of any one of Inventive Concepts 36 to 38, wherein the weighing kit comprises electronic circuitry disposed thereupon and programmed to display, on a screen, a weight of a product placed in the holding volume of the basket member or removed therefrom, or of a product placed on the suspended shelf or removed therefrom.

Inventive Concept 40. The shopping cart of any one of Inventive Concepts 36 to 39, wherein the weighing kit comprises electronic circuitry disposed thereupon and programmed to subtract at least a combined weight of the basket member and the suspended shelf, from a total weight measured or calculated by the one or more load cell assemblies, and to display and/or record a result of the subtracting.

Inventive Concept 41. The shopping cart of any one of Inventive Concepts 36 to 40, wherein the weighing kit additionally comprises a lower frame joined to the base member and an upper frame joined to the basket member, wherein the one or more load-cell assemblies are arranged to mediate between the lower frame and the upper frame.

Inventive Concept 42. The shopping cart of any one of Inventive Concepts 36 to 41, wherein the joining of the lower frame to the base member and the joining of the upper frame to the basket member are non-destructively reversible.

Inventive Concept 43. The shopping cart of any one of Inventive Concepts 36 to 42, additionally comprising a handle member supported solely by the base member such that the one or more strain gages do not register a weight of the handle member.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

What is claimed is:

1. A shopping cart comprising:
a. a basket member comprising a volume for holding products;
b. a base member comprising a plurality of wheels supporting the base member, an upper portion of the base member comprising a coupling feature shaped and arranged to be reversibly joined to a lower portion of the basket member when the shopping cart is in an assembled, non-weighing configuration; and
c. a weighing kit comprising (i) a lower frame, (ii) an upper frame comprising a coupling feature that emulates the coupling feature of the upper portion of the base member, and (iii) a load-cell assembly mediating between the lower frame and the upper frame, the load cell assembly comprising a flexure arrangement and a strain gage,
wherein, when the shopping cart is in an assembled weighing-enabled configuration such that a weight of the basket member is registered by the strain gage, (i) the lower frame of the weighing kit is joined to the coupling feature of the base member and is non-destructively separable therefrom, and (ii) the coupling feature of the upper frame of the weighing kit is joined to the basket member and is non-destructively separable therefrom.

2. The shopping cart of claim 1, wherein the weighing kit comprises electronic circuitry programmed to transmit information about a weight registered by the strain gage, the electronic circuitry being disposed on one or more of the lower frame, the upper frame, and the load-cell assembly.

3. The shopping cart of either one of claim 1 or 2, wherein the weighing kit comprises electronic circuitry disposed on one or more of the lower frame, the upper frame, and the load-cell assembly, and programmed to record, in a non-transient computer-readable medium, a weight of a product placed in the holding volume of the basket member or removed therefrom when the shopping cart is in the assembled weighing-enabled configuration.

4. The shopping cart of any one of the preceding claims, wherein the weighing kit comprises electronic circuitry disposed on one or more of the lower frame, the upper frame, and the load-cell assembly, and programmed to display, on a screen, a weight of a product added to or removed from the basket member when the shopping cart is in the assembled weighing-enabled configuration.

5. The shopping cart of any one of the preceding claims, wherein the weighing kit comprises electronic circuitry disposed on one or more of the lower frame, the upper frame, and the load-cell assembly, and programmed to subtract at least a weight of the basket member from a total weight measured or calculated by the load cell assembly when the shopping cart is in the assembled weighing-enabled configuration, and to display and/or record a result of the subtracting.

6. The shopping cart of any one of the preceding claims, additionally comprising a shelf member suspended from the basket member and/or from the upper frame of the weighing kit, such that when the shopping cart is in the assembled weighing-enabled configuration, a weight of the suspended shelf member is registered by the strain gage.

7. The shopping cart of any one of the preceding claims, wherein (i) the weighing kit additionally comprises at least one additional load-cell assembly, each additional load-cell assembly mediating between the lower frame and the upper frame, and comprising a flexure arrangement and a strain gage, (ii) when the shopping cart is in the assembled weighing-enabled configuration, a weight of the basket member is registered by, and distributed among, all of the strain gages of the weighing kit.

8. A method of assembling the shopping cart of any one of claims 1 to 7, the method comprising:
a. joining the lower frame of the weighing kit to the base member, and the coupling feature of the upper frame of the weighing kit to the basket member; and
b. installing the load cell assembly between the lower frame and the upper frame to mediate therebetween.

9. The method of claim 8, wherein the installing is performed before the joining.

10. The method of either one of claim 8 or 9, wherein, after the joining and the installing, a weight of the basket member is registered by the strain gage

11. A method of converting, from the non-weighing configuration to the weighing-enabled configuration, the shopping cart of any one of claims 1 to 7, the method comprising:
a. non-destructively separating the basket member of the shopping cart from the base member thereof;
b. joining the lower frame of the weighing kit to the separated base member, and the coupling feature of the upper frame of the weighing kit to the separated basket member; and
c. installing the load cell assembly between the lower frame and the upper frame to mediate therebetween.

12. The method of claim 11, wherein the installing is performed before the joining.

13. The method of either one of claim 11 or 12, wherein, after the joining and the installing, a weight of the basket member is registered by the strain gage

14. A method of assembling a weighing-enabled shopping cart, the method comprising:
a. providing:
i. a basket member of a shopping cart, the basket member comprising a volume for holding products,
ii. a base member of a shopping cart, the base member comprising a plurality of wheels supporting the base member, an upper portion of the base member comprising a coupling feature shaped and arranged to be reversibly joined to a lower portion of the basket member, and
iii. a weighing kit comprising a lower frame shaped for being joined to the base member, an upper frame comprising a coupling feature that emulates the coupling feature of the upper portion of the base member, and a load cell assembly comprising a flexure arrangement and a strain gage;
b. joining the lower frame of the weighing kit to the base member, and the coupling feature of the upper frame of the weighing kit to the basket member; and
c. installing the load cell assembly between the lower frame and the upper frame to mediate therebetween.

15. The method of claim 14, wherein the installing is performed before the joining.

16. The method of claim 14, wherein the installing is performed before the providing.

17. The method of any one of claims 14 to 16, wherein the provided base member and basket member are mechanically coupled to each other without welding, the method additionally comprising, before the joining: non-destructively separating the basket member from the base member.

18. The method of any one of claims 14 to 17, wherein the joining of the lower frame to the base member and the joining of the upper frame to the basket member are non-destructively reversible.

19. The method of any one of claims 14 to 18, wherein, after the joining and the installing, a weight of the basket member is registered by the strain gage.

20. The method of any one of claims 14 to 19, wherein the weighing kit comprises electronic circuitry disposed on one or more of the lower frame, the upper frame, and the load-cell assembly, and programmed to transmit information about a weight registered by the strain gage.

21. The method of any one of claims 14 to 20, wherein the weighing kit is provided in an assembled state wherein the load cell assembly is installed between the lower frame and the upper frame.

22. A weighing-enabled shopping cart assembled in accordance with the method of any one of claims 14 to 21.

23. A shopping cart converted from the non-weighing configuration to the weighing-enabled configuration in accordance with the method of any one of claims 17 to 21.

24. A method of converting, from a non-weighing configuration to a weighing-enabled configuration, a shopping cart comprising a basket member and a base member, wherein an upper portion of the base member comprises a coupling feature reversibly joined, without welding, to a lower portion of the basket member, the method comprising:
a. non-destructively separating the basket member of the shopping cart from the base member thereof;
b. providing a weighing kit comprising a lower frame shaped for being joined to the base member, an upper frame comprising a coupling feature that emulates the coupling feature of the upper portion of the base member, and a load cell assembly comprising a flexure arrangement and a strain gage;
c. joining the lower frame of the weighing kit to the base member, and the coupling feature of the upper frame of the weighing kit to the basket member; and
d. installing the load cell assembly between the lower frame and the upper frame to mediate therebetween.

25. The method of claim 24, wherein the installing is performed before the joining.

26. The method of claim 24, wherein the installing is performed before the providing.

27. A shopping cart converted from the non-weighing configuration to the weighing-enabled configuration according to the method of any one of claims 24 to 26.

28. A shopping cart comprising:
a. a basket member comprising a volume for holding products;
b. a base member comprising a plurality of wheels supporting the base member;
c. a weighing kit comprising one or more load-cell assemblies, each load cell assembly comprising a flexure arrangement and a strain gage, the weighing kit interposed between the basket member and the base member such that the one or more strain gages register a weight of the basket member; and
d. a shelf member suspended from the basket member and/or from an upper frame of the weighing kit such that a weight of the suspended shelf member is registered by the one or more strain gages.

29. The shopping cart of claim 28, wherein the weighing kit comprises electronic circuitry disposed thereupon and programmed to transmit information about a weight registered by the one or more strain gages.

30. The shopping cart of either one of claim 28 or 29, wherein the weighing kit additionally comprises a lower frame joined to the base member and an upper frame joined to the basket member, wherein the one or more load-cell assemblies are arranged to mediate between the lower frame and the upper frame.
